(19) United States
(12) Patent Application Publication
(10) Pub. No.: US 2005/0058779 A1
(43) Pub. Date: Mar. 17, 2005

(54) Suppression of repellency in polyolefins

(76) Inventors: Richard H. Goldbaum, Wilmington, DE (US); Edward James Greenwood, Hockessin, DE (US); K. Spencer Prowse, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/661,923

(22) Filed: Sep. 12, 2003

(51) Int. Cl. B05D 3/02

(52) U.S. Cl. 427/374.1; 524/543; 524/562

(57) ABSTRACT

A method for temporarily suppressing repellency of an extruded or molded object, said object comprising a mixture of a polyolefin and a fluorocarbon/hydrocarbon ester, by heating the object to a temperature above 40° C., holding for at least 10 seconds, and cooling is disclosed.

### FIELD OF THE INVENTION

This invention relates to a method for imparting a time-delayed repellency to extruded or molded polyolefin objects, such as a fiber, sheet, film or molded article. It permits temporarily suppressing repellency of such an object for surface modification thereof.

### BACKGROUND OF THE INVENTION

Thermoplastic polymer surfaces, such as fibers, sheets, films or molded articles are frequently treated with fluorochemical compounds in order to affect the surface characteristics thereof, for example to improve water repellency or to impart stain or dry soil resistance or repellency. Most frequently, aqueous fluorochemical dispersions are applied topically to the surfaces by spraying, padding, or foaming, followed by a drying step to remove water.

However, the imparted repellency may cause application difficulties if the surface is to be decorated or printed with a picture, text, a logo or other decoration. Similar difficulties may arise in applying any other fluid, paste or solid material to the surface in applications such as adhesive application, thermobonding, laminating, dyeing, and the like. To avoid any such interference by the repellency properties, it may be necessary to interrupt the manufacturing process and perform the application on the surface before the topical application of the fluorochemical.

It is well recognized that the process of manufacturing thermoplastic polymers could be simplified and significant capital investment could be eliminated if the topical application were replaced by incorporating a fluorochemical additive into the polymer prior to the extrusion of the object. The prime difficulty has been in finding suitably effective fluorochemical additives. The requirements of an additive into a polyolefin melt include, besides the ability to repel low surface tension fluids at a low concentration of the additive, a satisfactory thermal stability and low volatility to withstand processing conditions. Preferably the compound will migrate to the surface of the object so as to minimize the amount of additive needed for adequate repellency. While this migration can often be enhanced by post-extrusion heating of the object, it has been considered more preferable for the migration to occur without the need for this heating step.

However, the extruded polymers modified in this way are typically repellent, not only to the desired fluids, but also to the printing inks or other materials used if one wishes to decorate or otherwise modify the surface of the polymer object. With an already-incorporated fluorochemical additive, it is impossible to carry out the product surface modification step in the pre-fluorochemical manner described above for a topically applied fluorochemical. This makes product modification difficult for polymers containing fluorochemical melt additives.

The prior art discloses examples of polyolefin fibers containing a fluorochemical additive incorporated at the melt stage to alter the surface characteristics of the extruded fiber, many of which employ a fluorocarbon/hydrocarbon ester. See, for example, U.S. Pat. No. 5,898,046. However, a way of avoiding or minimizing the potential difficulties caused by the repellency so created for other later fabric-modifying steps is not addressed.

When incorporating a fluorochemical additive in a polymer melt to create repellency in an extruded or molded object, there is a need for a method of temporarily suppressing this repellency so as to avoid or minimize any potential difficulties for other surface-modifying steps. The present invention provides such a method.

### SUMMARY OF THE INVENTION

The present invention comprises a method for temporarily suppressing the repellency of an extruded or molded object, said object comprising a mixture of a polyolefin polymer and a fluorocarbon/hydrocarbon ester, comprising heating the object to a temperature of above 40° C., holding for at least 10 seconds and cooling to about ambient temperature.

The present invention further comprises a method of modifying a surface of an extruded or molded object, said object comprising a mixture of a polyolefin polymer and a fluorocarbon/hydrocarbon ester, comprising heating the object to a temperature of above 40° C. for at least 10 seconds, cooling the object to about ambient temperature, and applying a surface modifier to the object within a period of about 48 hours after said cooling.

The present invention further comprises a composition comprising an extruded or molded mixture of a polyolefin polymer and a fluorocarbon/hydrocarbon ester, having a surface which is modified by heating to a temperature of above 40° C. for at least 10 seconds; cooling to about ambient temperature; and applying a surface modifier within a period of about 48 hours after said cooling.

The present invention further comprises an improved method of making extruded or molded objects having a modified surface wherein a fluorocarbon/hydrocarbon ester is added to a polyolefin melt prior to extrusion or molding wherein the improvement comprises incorporating a heating and cooling step prior to modification of the surface of the object.

### DETAILED DESCRIPTION OF THE INVENTION

This invention relates to a method for temporarily suppressing the repellency of an extruded or molded object, wherein the object comprises a mixture of a polyolefin polymer and a fluorocarbon/hydrocarbon ester, by heating the object to a temperature of about 40° C. for at least 10 seconds followed by cooling to ambient temperature. This heating and cooling results in temporarily suppressing the surface repellency of the object contributed by the fluorocarbon/hydrocarbon ester. This temporary suppression allows the surface of the object to be printed upon or otherwise modified by the addition of a surface modifier such as ink, adhesive, a thermobonded or laminated material, and the like that would otherwise be repelled or hindered by the repellency of the fluorocarbon/hydrocarbon ester.

This invention relates to a polyolefin object containing a fluorocarbon/hydrocarbon ester dispersed throughout the polyolefin, and provides a method for temporarily suppressing the repellency of said polyolefin so as to allow the addition of a surface modifier, or performance of surface modification, of said polyolefin object. The term “object” as used herein includes a fiber, filament, fabric, film, sheet, nonwoven, shaped article, molded article, or solid object. By a “surface modifier” is meant any material which changes the appearance or surface characteristics of the polyolefin object. Examples of surface modifiers include ink, dye, paint, adhesive, or a thermobonded or laminated material. By “polyolefin” is meant any polymer selected from the group consisting of a polyolefin, mixture of polyolefins, olefin copolymer, mixture of olefin copolymers, and mixture of at least one polyolefin and at least one olefin copolymer. In particular, it is meant to include any polyolefin having a polymer unit which is ethylene, propylene, butylene, or mixture thereof. The polyolefin object of this invention is an extruded, molded, or shaped polyolefin. Preferably the polyolefin object is a fabric, more preferably it is a spunbonded nonwoven polyolefin fabric.

By a fluorocarbon/hydrocarbon ester is meant a compound of the formulae:
R_{f}—O—C(O)—R₁ or R_{f}—C(O)—O—R₁
or mixtures thereof, wherein Rf is selected from the group consisting of F(CF₂)ₓ—(CH₂)ₘ wherein x is from about 4 to about 20 and m is from about 0 to about 6, and R₁ is an aliphatic linear hydrocarbon having from about 12 to about 76 carbon atoms. Preferably, the fluorocarbon/hydrocarbon ester is a perfluoroalkyl stearate.

Especially preferred is a composition which is a mixture wherein Rf has a chain length distribution as follows:

| | |
|---|---|
| x = 6 or less | 0-10% by weight |
| x = 8 | 45-75% by weight |
| x = 10 | 20-40% by weight |
| x = 12 | 1-20% by weight |
| x = 14 or greater | 0-5% by weight |

R₁ is an aliphatic hydrocarbon with a carbon chain length of about 12 to about 76 carbons, preferably from about 12 to about 50 carbons, more preferably from about 12 to about 22 carbon atoms, and most preferably an average of about 17 carbon atoms.

The fluorocarbon/hydrocarbon ester can be made by known processes. For example, the ester is made by reacting an appropriate alcohol with a fluorocarbon acid, or by reacting a fatty acid with an appropriate fluorocarbon alcohol, or by transecterfication. In the case of perfluoroalkyl stearate, it is preferably made by ester interchange between a perfluoroalkyl alcohol and methyl stearate or by the direct combination of the perfluoroalkyl alcohol with stearic acid. Preferably the fluorocarbon/hydrocarbon ester is made by the direct combination of the perfluoroalkyl alcohol with stearic acid. A suitable perfluoroalkyl stearate may be purchased from E. I. du Pont de Nemours and Company, Wilmington, DE, as ZONYL FTS or as TLF-9483.

Longer chain alcohols corresponding to R₁—OH, useful in the preparation of the fluorocarbon/hydrocarbon ester, are commercially available from Petrolite Corporation, Polymer Division Headquarters, 6910 E. 14th Street, Tulsa, Okla., USA 74112, under the trademark “UNILIN”. “UNILIN” alcohols are fully saturated long chain linear alcohols.

The approximate R₁ ranges of “UNILIN” 350, 425, 550 and 700 are 12 to 50, 14 to 58, 16 to 56 and 14 to 66, respectively. The average chain lengths for “UNILIN” 350, 425, 550 and 700 are about 24, 32, 40 and 48, respectively. Acids corresponding to R₁—COOH, useful in the preparation of the fluorocarbon/hydrocarbon ester, are commercially available from Petrolite Corporation, Polymers Division Headquarters, 6910 E. 14th Street, Tulsa, Okla., 74112, under the trademark “UNICID”. The range of average chain lengths for “UNICID” 350, 425, 550 and 700 are 24-29, 29-37, 37-45 and 40-48, respectively.

It is desirable that the fluorocarbon/hydrocarbon ester have minimum volatility at the extrusion or molding temperatures. This is desirable so as to have better control over the amount in the final product, to minimize any pollution problems, and to reduce ingredient costs. Minimum volatility can be achieved by minimizing any volatile perfluoroalkyl constituents or impurities, as is done in the above-cited TLF9483, and/or by adding stabilizers known to the trade.

The fluorocarbon/hydrocarbon ester is present in the amount of from about 0.3% to about 2% by weight relative to the weight of polyolefin.

Amounts below 0.3% are ineffective in providing the desired repellency after treatment. Amounts above 2% are unnecessary and may not allow adequate suppression of repellency for the subsequent application.

The ester is added to the polyolefin melt to form a mixture which is then extruded, molded or shaped. Alternatively, the ester is mixed with the polyolefin by adding it to pelletized, granular, powdered, or other appropriate forms of the polymer and rolling, agitating, or compounding the mixture to achieve a uniform mixture which is then melt extruded, molded or otherwise shaped.

The fluorocarbon/hydrocarbon ester may be combined with the polyolefin as a masterbatch with polyolefin, or by itself, or with other substances. For example, it may contain a substance to reduce volatility, a colorant, an odorant, a reflectant, a texturant, a softener, a fire retardant, or any other material to alter the characteristics of the polyolefin.

The polyolefin object is extruded or molded by methods well known in the art. After extrusion or molding, the polyolefin object is allowed to cool until it reaches a temperature where it is readily handled without safety or product distortion problems. Preferably it is allowed to cool to about ambient temperature. Once it is at ambient temperature, it may be held indefinitely, stored or shipped before the treatment of this invention is applied. By about ambient temperature is meant any temperature typically found in inhabited rooms or buildings.

When it is time for the addition of a surface modifier, the object is heated to a temperature above 40° C. for at least 10 seconds, and then recooled to about ambient temperature. This will suppress the repellency for a period up to one or two days. This result is unexpected. The prior art indicates that heating or annealing a polyolefin containing a fluorocarbon/hydrocarbon ester melt additive may be used to increase its repellency, not to decrease it. For example, see U.S. Pat. No. 5,898,046, at Col. 6, lines 51-57.

Heating temperatures of 40° C. or below and holding times below 10 seconds are generally inadequate to provide the repellency suppression desired for the addition of the surface modifier. Preferably the heating temperature is above about 60° C. More preferably the heating temperature is above about 70° C. Preferably the heating temperature is below about 150° C. Temperatures above 150° C. are also satisfactory up to the temperature where the product may be too soft and easily distortable or otherwise deteriorated, or where the higher temperature may pose a safety problem. Preferably the hold time is above about one minute. Longer times are also suitable, for example above about five minutes. The maximum time is limited only by convenience or by possible product deterioration after extended periods at high temperature. Hold times between about one and about fifteen minutes are preferred for use herein, especially for thin films and fabrics. Somewhat longer times may be preferred for thicker cast or extruded objects. The optimum time for a particular application is easily determined by one skilled in the art.

The polyolefin is then allowed to recool to about ambient temperature. The suppressed repellency will be in effect for a period of several hours to about 48 hours, after which it will return to its normally desired repellency. This suppression period may vary somewhat with the amount of fluorocarbon/hydrocarbon ester, the characteristics of the polyolefin object such as its polymer constituents, the object form or thickness, the actual room temperature, and/or other matters. For maximum suppression of repellency, the product modification step should be carried out with the suppression period at its minimum practical value, preferably up to about 24 hours, more preferably about one to ten hours.

The polyolefin object is then modified by adding or applying a surface modifier such as ink, dye, paint, adhesive, or thermobonded or laminated materials. If the addition of the surface modifier is postponed for any reason, such that the repellency of the polyolefin object has returned, the above heating treatment may be repeated to again suppress the repellency for a period of time. Thus, operations such as printing, dyeing, painting, adhesive application, thermobonding and laminating are performed on the object surface without interference from the repellency.

The present invention further comprises a composition comprising an extruded or molded object having a surface modified by the above described method of heating to a temperature of above 40° C. for at least 10 seconds, cooling to about ambient temperature, and applying a surface modifier within a period of 48 hours after said cooling. As previously noted, the composition of the present invention comprises a polyolefin and a fluorocarbon/hydrocarbon ester. After such heating/cooling treatment, the repellency recovers within about 24 to about 48 hours of heating. Thus, the repellency properties provided by the fluorocarbon/hydrocarbon ester are retained in the final surface-modified object. The composition can be of any physical shape or form that can be achieved by extruding, molding, or shaping the polymer and ester mixture. The composition optionally contains other components such as additives to reduce volatility, colorant, odorant, reflectant, texturant, softener, fire retardant, or materials to achieve desired surface effects.

The present invention is useful to permit a producer to make repellent polyolefin goods without the need for specialized finishing equipment. A downstream converter can de-activate the repellency by a short heat treatment, so that converting operations (i.e. dyeing, printing, painting, adhesive application, thermobonding, laminating) can now proceed without special handling or additives to overcome the latent repellency in the polyolefin. The repellency then recovers within 24 to 48 hours of the heat treatment.

The present invention further comprises an improved method of making extruded or molded objects having a modified surface wherein a fluorocarbon/hydrocarbon ester is added to a polyolefin prior to extrusion or molding wherein the improvement comprises incorporating a heating and cooling step prior to modification of the surface of the object. The heating and cooling step and surface modification are as previously detailed herein. The improved method of making extruded or molded objects of the present invention allows the manufacturer of repellent polyolefin articles having decorated or modified surfaces to incorporate the repellency deactivation as described herein into the manufacturing operation by simple addition of a heating/cooling step. Such a heating/cooling step is incorporated prior to the surface modification step. The repression of the repellency of the object permits easier more efficient surface modification.

The following examples are intended to illustrate the invention, and are not to be interpreted as limiting the scope of the invention in any way. These examples utilize melt blown nonwoven polypropylene fabrics containing a fluorocarbon/hydrocarbon ester. These are prepared by methods as described in Example 16 of previously referenced U.S. Pat. No. 5,898,046.

The repellency properties of the melt blown webs in the examples hereafter were measured using an isopropyl alcohol/water test and are expressed in terms of percent isopropyl alcohol rating. Webs that resisted penetration of a 100% isopropyl alcohol/0% water solution (lowest surface tension fluid) after 5 minutes were given the highest rating of 100. Webs that were only resistant to a 100% water/0% isopropyl alcohol solution after 5 minutes were given the lowest rating of 0. Table 1 lists ratings that correspond to other isopropyl alcohol/water mixtures used in this test. The rating for a given fabric corresponds to the lowest surface tension fluid (greatest % isopropyl alcohol content) that does not wet the fabric after 5 minutes.

TABLE 1
Percent Isopropyl Alcohol Ratings

| Rating | % Isopropyl alcohol/water (wt./.wt.) |
|---|---|
| 100 | 100/0 |
| 90 | 90/10 |
| 80 | 80/20 |
| 70 | 70/30 |
| 60 | 60/40 |
| 50 | 50/50 |
| 40 | 40/60 |
| 30 | 30/70 |
| 20 | 20/80 |
| 10 | 10/90 |
| 0 | 0/100 |

### EXAMPLES

### Example 1

A meltblown nonwoven polypropylene fabric containing 1.0% TLF-9483 available from E. I. du Pont de Nemours and Company, Wilmington, Del., was measured for repellency according to the method described above. It was found to have a repellency of 90 (able to hold out 90% isopropyl alcohol). After heating the fabric for 5 minutes at 100° C. and cooling to ambient temperature, the repellency was again measured by the same method and was found to be 30 (only able to hold out 30% isopropyl alcohol). After 10 minutes following heating the repellency recovered to 60. After 72 hours the repellency was 70+.

A red ink was used to simulate a dye. The initial fabric with a 90 repellency was treated with a drop of the ink. It showed no tendency to wet out the fabric as evidenced by insignificant wicking or spreading out. After heating and cooling the fabric to obtain a 30 repellency as described above, the red ink spread out or wicked out from the point of application. After 72 hours the ink was applied and again there was little wicking or spreading, indicating that the repellency had recovered. Also, the ink that had been applied immediately after heating continued to show good adhesion to the surface of the fabric.

### Example 2

A spunbond polypropylene fabric containing 0.75% Zonyl FTS, available from E. I. du Pont de Nemours and Company, Wilmington, Del., was measured for repellency according to the method described above. It was found to have an initial repellency rating of 70. The fabric was then heated to 100° C. for 3 minutes and then the repellency was measured at various times after the heating period. The following results in Table 2 were obtained.

TABLE 2
Repellency Ratings versus Recovery Time

| Initial | After Heating | 0.5 hr | 1 hr | 1.5 hr | 2 hr | 3 hr | 4 hr | 20 hr |
|---|---|---|---|---|---|---|---|---|
| 70 | 30 | 30 | 40 | 50 | 60 | 60 | 60 | 70 |

The data showed that the heating effect to suppress repellency and the recovery of repellency is achieved with a different fluorochemical present in the polypropylene.

### Example 3

Two meltblown fabrics were generated with different concentrations of TLF-9483 as in Example 1. The fabrics were heated to 66° C. for 5 minutes and then the repellency was measured at various times after the heating period. The following results in Table 3 were obtained.

TABLE 3
Repellency Ratings versus Recovery Time and % Fluorochemical

| | | Time after Heating | | | |
|---|---|---|---|---|---|
| % Fluorochemical | Initial(before heating) | 5 min | 0.5 hr | 1 hr | 3 hr |
| 0.9 | 80 | 65 | 70 | 70 | 70 |
| 0.7 | 80 | 60 | 60 | 70 | 70 |

### Example 4

Polypropylene-based meltblown nonwoven fabric samples containing 0.8% TLF-9483 as in Example 1 were heated at various temperatures for various times. The alcohol repellency was determined over the time range of 5 min to 24 hours after heating. The results are shown below in Table 4A.

TABLE 4A
Repellency Ratings versus Heating Conditions and Recovery Time

| | Recovery Time | | | | | | |
|---|---|---|---|---|---|---|---|
| Heating | 5 min | 30 min | 1 hr | 2 hr | 3 hr | 4 hr | 24 hr |
| 40° C. for 1 Min | 80 | 80 | 80 | 80 | 80 | 80 | 80 |
| 40° C. for 5 Min | 80 | 80 | 80 | 80 | 80 | 80 | 80 |
| 50° C. for 1 Min | 60 | 60 | 60+ | 70 | 70 | 70 | 70 |
| 50° C. for 3 Min | 60 | 60 | 70 | 70 | 70 | 70 | 70 |
| 60° C. for 1 Min | 40 | 40+ | 50 | 50 | 50+ | 50+ | 70 |
| 60° C. for 3 Min | 40 | 40+ | 50 | 50 | 50+ | 60 | 70 |
| 70° C. for 3 Min | 30 | 30 | 30 | 30 | 40 | 40 | 50 |
| 70° C. for 3 Min | 30 | 30 | 30 | 30 | 40 | 40 | 50 |
| 100° C. for 1 Min | 20 | 20 | 20 | 20 | 40 | 40 | 50 |
| 100° C. for 5 Min | 20 | 20 | 20 | 20 | 20+ | 40 | 50 |

Note:
Initial repellency rating before heating = 80

The above results showed observable effects at heating temperatures above 40° C., with optimum results at 100° C. There was little difference in repellency for 1 minute versus 5 minutes. Repellency was only partially recovered after 24 hours.

To determine a lower heating time limit, the above tests were repeated for shorter heating times, with a recovery time of 5 minutes. Results are shown in Table 4B.

TABLE 4B
Repellency Ratings versus Heating Conditions and Recovery Time

| Recovery Time | 5 min |
|---|---|
| Heating | Repellency |
| 50° C. for 0 Sec. | 80 |
| 50° C. for 10 Sec. | 80 |
| 50° C. for 20 Sec. | 80 |
| 50° C. for 30 Sec. | 80 |
| 50° C. for 40 Sec. | 70 |
| 100° C. for 0 Sec. | 80 |
| 100° C. for 10 Sec. | 20 |

The above tests show that a heating time of only 10 seconds at 100° C. is adequate to suppress repellency.

### Example 5

A 3.8 inch (8.8 cm) diameter by 0.25 inch (0.6 cm) thick disk of polypropylene containing 1% TLF-9483 available from E. I. du Pont de Nemours and Company, Wilmington, Del., was cast in a glass evaporating dish by melting a polymer mixture in the dish on a hot plate. The casting was done at 175° C. and then the disk was allowed to cool. The repellency rating was measured over the next 168 hours. The resulting data are listed in the first two columns of Table 5 below. The disk was then placed in an oven at 110° C. for 1 hour. The disk was removed from the oven and allowed to cool. The repellency was measured after 30 minutes and gave a rating of 80, indicating that 1 hour heating at 110° C. was inadequate to suppress repellency for so thick a sample. The disk was then put back into the oven at 110° C. for an additional hour to give 2 hours total exposure. The repellency rating was measured over the next 216 hours. The results are shown below in Table 5.

TABLE 5
Disk Repellency Ratings versus Hold Time

| | | | Time after | | |
|---|---|---|---|---|---|
| Time after initial | | Repellency | heating disk to | | Repellency |
| formation of disk | | Rating | 110° C. for 2 hr | | Rating |
| 30 | min | 60 | 30 | min | 30 |
| 90 | min | 60 | 90 | min | 50 |
| 150 | min | 60 | 150 | min | 50 |
| 210 | min | 60 | 210 | min | 50 |
| 270 | min | 60 | 120 | hrs | 50 |
| 330 | min | 60 | 144 | hrs | 60 |
| 390 | min | 60 | 168 | hrs | 60 |
| 24 | hrs | 60 | 192 | hrs | 60 |
| 48 | hrs | 60 | 216 | hrs | 80 |
| 72 | hrs | 60 | 216 | hrs | 80 |
| 96 | hrs | 60 | | | |
| 168 | hrs | 60 | | | |

### Example 6

One sample of polypropylene-based meltblown nonwoven fabric containing 0.8% TLF-9483 was heated in an oven at 100° C. for 20 seconds. Another sample of the same fabric was not heated (control). The initial alcohol repellency was 80. The alcohol repellency of the heated sample was reduced to 20. Adhesive was applied to the heated sample immediately after removal from the oven and to the unheated sample. The repellency of the heated sample improved over time to 60. The dried adhesive was then removed from each sample. The dried adhesive was more difficult to remove from the heated and aged sample vs. the unheated sample. The results show that the improved repellency with time after the application of the adhesive did not interfere with adhesion as compared to the control.

1. A method for temporarily suppressing the repellency of an extruded or molded object, said object comprising a mixture of a polyolefin polymer and a fluorocarbon/hydrocarbon ester, comprising heating the object to a temperature of above 40° C., holding for at least 10 seconds and cooling to about ambient temperature.

2. The method of claim 1 wherein the heating temperature is above about 60° C. and the holding time is above about 1 minute.

3. The method of claim 2 wherein the heating temperature is above about 70° C. and the holding time is above about 5 minutes.

4. The method of claim 3 wherein the heating temperature is from about 70° C. to about 150° C. and the holding time is from about 1 to about 15 minutes.

5. The method of claim 1 wherein the object is selected from the group consisting of fibers, filaments, fabrics, films, sheets, nonwoven, molded articles, shaped articles, and solid objects.

6. The method of claim 5 wherein the object is a nonwoven fabric.

7. A method of modifying a surface of an extruded or molded object, said object comprising a mixture of a polyolefin polymer and a fluorocarbon/hydrocarbon ester, comprising heating the object to a temperature of above 40° C. for at least 10 seconds, cooling the object to about ambient temperature, and applying a surface modifier to the object within a period of about 48 hours after said cooling.

8. The method of claim 7 wherein the applying of a surface modifier is selected from the group consisting of printing, dyeing, painting, adhesive application, thermobonding, and laminating.

9. The method of claim 7 wherein the heating temperature is from about 70° C. to about 150° C. and the holding time is from about 1 to about 15 minutes.

10. A composition comprising an extruded or molded mixture of a polyolefin polymer and a fluorocarbon/hydrocarbon ester, having a surface which is modified by heating to a temperature of above 40° C. for at least 10 seconds; cooling to about ambient temperature; and applying a surface modifier within a period of 48 hours after said cooling.

11. The composition of claim 10 wherein the surface is modified by at least one of printing, dyeing, painting, applying adhesive, thermobonding or laminating.

12. The composition of claim 10 wherein the heating temperature is from about 70° C. to about 150° C. and the holding time is from about 1 to about 15 minutes.

13. An improved method of making extruded or molded objects having a modified surface wherein a fluorocarbon/hydrocarbon ester is added to a polyolefin prior to extrusion or molding wherein the improvement comprises incorporating a heating and cooling step prior to modification of the surface of the object.

14. The method of claim 13 wherein heating is to a temperature above 40° C. for at least 10 seconds.

15. The method of claim 14 wherein heating is to a temperature of from about 70° C. to about 150° C. for a time of from about 1 minute to about 15 minutes.
